(19) United States
(12) Patent Application Publication
(10) Pub. No.: US 2017/0082309 A1
(43) Pub. Date: Mar. 23, 2017

(54) AIR-CONDITIONING SYSTEM

(71) Applicant: Mitsubishi Electric Corporation, Tokyo (JP)

(72) Inventor: Yasuhiko TANAKA, Tokyo (JP)

(73) Assignee: Mitsubishi Electric Corporation, Tokyo (JP)

(21) Appl. No.: 15/311,211

(22) PCT Filed: Jun. 17, 2014
(86) PCT No.: PCT/JP2014/066064

§ 371 Date: Nov. 15, 2016

(51) Int. Cl. F24F 11/00; G05B 13/02

(52) U.S. Cl. CPC F24F 11/006; F24F 11/0034; F24F 11/0012; F24F 11/0015; G05B 13/026; F24F 2011/0049; F24F 2011/005; F24F 2011/0013; F24F 2011/0068; F24F 2011/0047; F24F 2011/0073; F24F 2011/0075; F24F 2011/0061; G05B 2219/2614; G05B 2219/40341

(57) ABSTRACT

An air-conditioning system includes air-conditioning apparatuses each including an air-conditioning device involved in air conditioning of an air-conditioned space, and a centralized management remote controller configured to perform rotation control in which an operating state of each of the air-conditioning apparatuses is controlled by being set to be switched for each rotation time. The centralized management remote controller includes a centralized management remote controller communication unit configured to communicate with the air-conditioning device connected by a communication line, and a centralized management remote controller control unit configured to set the rotation time depending on an air conditioning load of each of the air-conditioning apparatuses based on data transmitted from the air-conditioning device through communications with the centralized management remote controller communication unit when the centralized management remote controller control unit sets the operating state of each of the air-conditioning apparatuses.

### TECHNICAL FIELD

The present invention relates to an air-conditioning system. In particular, the present invention relates to an air-conditioning system in which air-conditioning apparatuses are controlled in rotation.

### BACKGROUND ART

A conventional air-conditioning system has a plurality of air-conditioning apparatuses in which a centralized management remote controller is used to perform rotation control by switching operating states of the respective air-conditioning apparatuses at predetermined rotation intervals (see Patent Literature 1, for example).

### CITATION LIST

### Patent Literature

Patent Literature 1: Japanese Unexamined Patent Application Publication No. 2000-283530 (FIG. 1)

### SUMMARY OF INVENTION

### Technical Problem

For example, in a conventional air-conditioning system as disclosed in Patent Literature 1 or other patent literatures, a centralized management remote controller executes a preinstalled control program to perform rotation control of air-conditioning apparatuses. Thus, operating states of the air-conditioning apparatuses cannot be switched until a predetermined rotation interval has elapsed, for example.

Further, as rotation control is performed based on a preset control program, control cannot be performed depending on variation of the load (air conditioning load) in the air-conditioned space.

As described above, a conventional air-conditioning system has a problem in that flexible control cannot be performed even in the case where air-conditioning is not needed or in an area having a low air conditioning load, because control is performed based on a preinstalled control program.

The present invention has been made to solve the problem described above. An object of the present invention is to provide an air-conditioning system capable of performing control depending on an air conditioning load.

### Solution to Problem

An air-conditioning system according to an embodiment of the present invention includes air-conditioning apparatuses each including an air-conditioning device involved in air conditioning of an air-conditioned space, and a management device configured to perform rotation control in which an operating state of each of the air-conditioning apparatuses is controlled by being set to be switched for each rotation interval. The management device includes a communication unit configured to communicate with the air-conditioning device connected by a communication line, and a controller configured to set the rotation interval depending on an air conditioning load of each of the air-conditioning apparatuses based on data transmitted from the air-conditioning device through communications with the communication unit when the controller sets the operating state of each of the air-conditioning apparatuses.

### Advantageous Effects of Invention

An embodiment of the present invention is configured to perform control so that data transmitted from the respective air-conditioning devices is reflected in rotation control and rotation intervals, thus providing an air-conditioning system in which respective air-conditioning apparatuses are integrally controlled. Consequently, energy saving and comfortability can be enhanced in the entire system.

### BRIEF DESCRIPTION OF DRAWINGS

FIG. 1 is a diagram illustrating an exemplary schematic configuration of an air-conditioning system 1 according to Embodiment 1 of the present invention.

FIG. 2 is a diagram illustrating configurations of an outdoor unit 20, an indoor unit 30, and an air-conditioning remote controller 60 according to Embodiment 1 of the present invention.

FIG. 3 is a diagram illustrating a configuration of a centralized management remote controller 10 according to Embodiment 1 of the present invention.

FIG. 4 is a flowchart relating to an example of rotation control performed by the centralized management remote controller 10 according to Embodiment 1 of the present invention.

FIG. 5 is a diagram illustrating an example of a rotation control edit screen according to Embodiment 1 of the present invention.

FIG. 6 is a flowchart of a detailed example of a rotation control command performed by a centralized management remote controller control unit 101 according to Embodiment 1 of the present invention.

FIG. 7 is a flowchart relating to an example of a rotation control content changing process performed by the centralized management remote controller 10 according to Embodiment 1 of the present invention.

FIG. 8 illustrates an example of rotation control data according to Embodiment 1 of the present invention.

FIG. 9 illustrates an example of data stored in a rotation control data storage unit 104 according to Embodiment 1 of the present invention.

### DESCRIPTION OF EMBODIMENTS

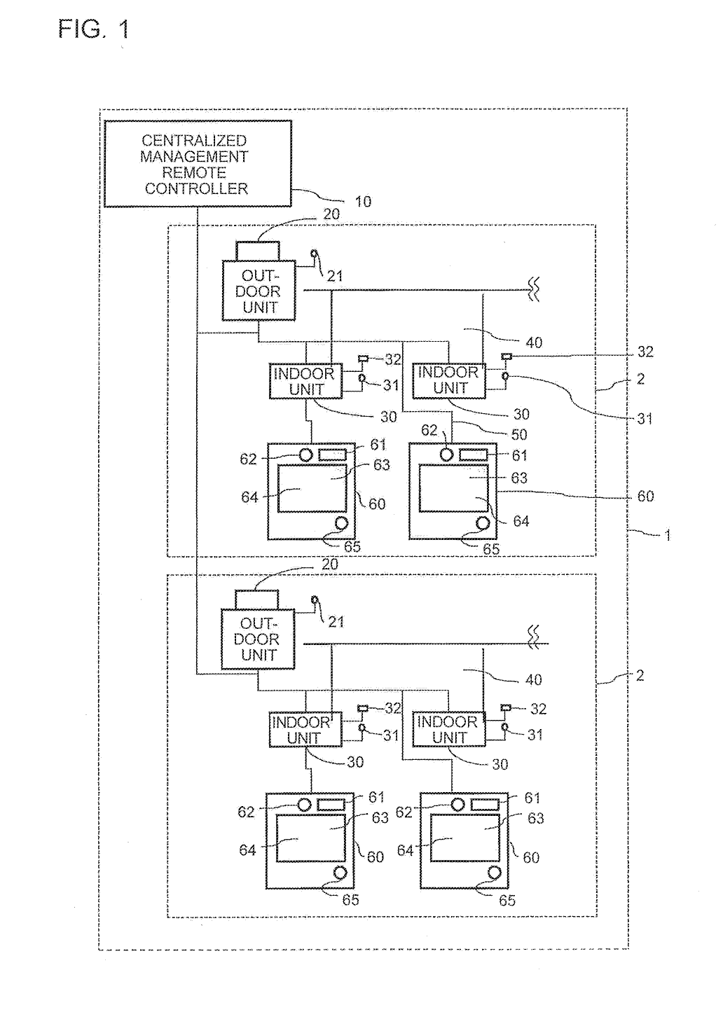

Hereinafter, an air-conditioning system according to embodiments of the invention will be described with reference to the drawings. In the drawings described below including FIG. 1, those denoted by the same reference signs are identical or equivalent to each other. The reference signs are common in the entire description of the embodiments provided below. Further, the forms of the components described in the entire description are provided for illustrative purposes, and are not limited to the forms described in the description. In particular, combinations of components are not limited to the combinations described in the respective embodiments. Components described in one embodiment may be applied to another embodiment. For example, a centralized management remote controller 10 and an air-conditioning apparatus 2 are examples. The configurations of the centralized management remote controller 10 and the air-conditioning apparatus 2 are not limited to those described below.

### Embodiment 1

FIG. 1 is a diagram illustrating an exemplary schematic configuration of an air-conditioning system 1 according to Embodiment 1 of the present invention. In Embodiment 1, in the air-conditioning system 1, a centralized management remote controller 10 serving as a management device of a plurality of air-conditioning apparatuses 2 collects, manages, and controls various data of respective devices constituting the air-conditioning apparatuses 2 via exclusive transmission line 50 to appropriately perform rotation control and enhance energy saving and comfortability of the entire system. Thus, hereinafter, description will be mainly given on the device configuration and operation relating to communications and the control system of the air-conditioning system 1.

As illustrated in FIG. 1, the air-conditioning system 1 includes the centralized management remote controller 10, and one or a plurality of air-conditioning apparatuses 2. Each of the air-conditioning apparatuses 2 includes one or a plurality of outdoor units 20, one or a plurality of indoor units 30, and one or a plurality of air-conditioning remote controllers 60. For example, in FIG. 1, each of the air-conditioning apparatuses 2 includes one outdoor unit 20, two indoor units 30, and two air-conditioning remote controllers 60. The centralized management remote controller 10 and the air-conditioning apparatus 2 (devices constituting the air-conditioning apparatus 2) are connected communicably with each other via the exclusive transmission line 50.

The exclusive transmission line 50 is a signal carrying medium in which communications conforming to a unique communication protocol in the air-conditioning system 1 are performed, for example.

Next, the air-conditioning apparatus 2 will be described, Each of the air-conditioning apparatuses 2 is controlled based on a signal including a control command and other data transmitted from the centralized management remote controller 10 via the exclusive transmission line 50. Further, the air-conditioning apparatus 2 transmits a signal included data required by the centralized management remote controller 10 to perform control to the centralized management remote controller 10.

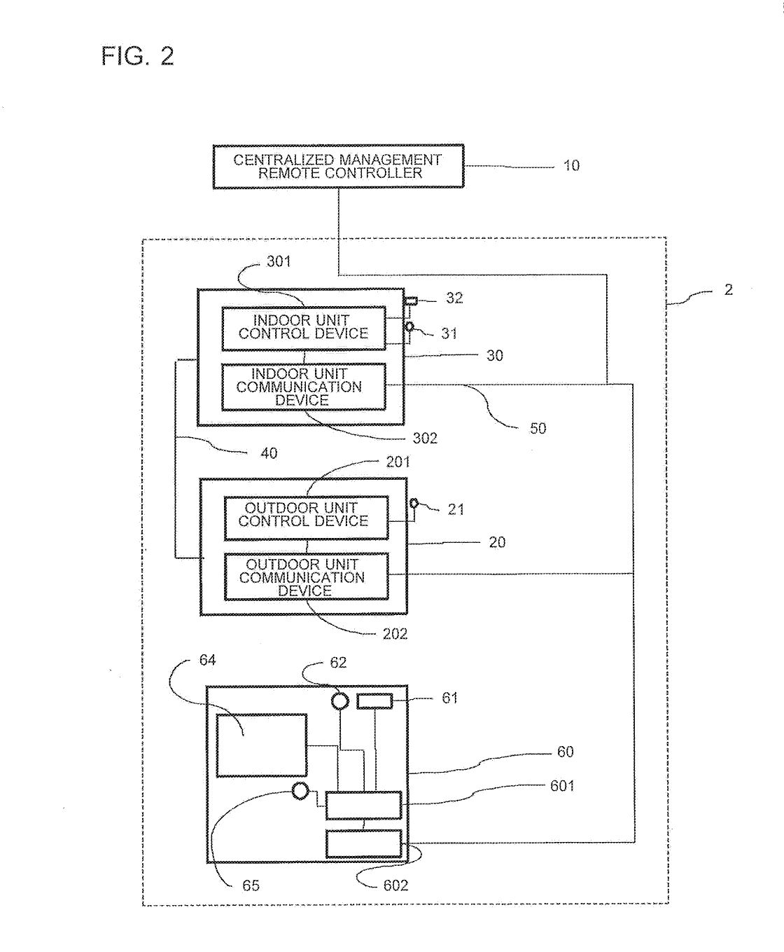

FIG. 2 is a diagram illustrating configurations of the outdoor unit 20, the indoor unit 30, and the air-conditioning remote controller 60 according to Embodiment 1 of the present invention, The outdoor unit 20 and the indoor unit 30 transmit and receive various types of signals to and from the centralized management remote controller 10, and operate based on various types of control commands included in signals from the centralized management remote controller 10. Further, the outdoor unit 20 and the indoor unit 30 are connected by a refrigerant pipe 40.

The outdoor unit 20 includes an outdoor unit control device 201 and an outdoor unit communication device 202. The outdoor unit control device 201 controls devices such as a compressor in the outdoor unit 20, based on the data obtained via the outdoor unit communication device 202 and the temperature related to detection by an outdoor unit temperature sensor 21. Further, the outdoor unit control device 201 allows the outdoor unit communication device 202 to transmit a signal including data to be used by the centralized management remote controller 10 to perform processing. The outdoor unit communication device 202 serves as an interface for the outdoor unit control device 201 to communicate (transmit and receive) with other devices via the exclusive transmission line 50. The outdoor unit temperature sensor 21 is a detection device configured to detect temperature (air temperature) around the outdoor unit 20. While the outdoor unit temperature sensor 21 is described as a component of the configuration of the outdoor unit 20 in this example, the outdoor unit temperature sensor 21 may be provided as a separate unit, for example, as long as the outdoor unit temperature sensor 21 can detect temperature around the outdoor unit 20.

The indoor unit 30 includes an indoor unit control device 301 and an indoor unit communication device 302. The indoor unit control device 301 controls device such as a fan in the indoor unit 30, based on the data obtained via the indoor unit communication device 302 and the temperature related to detection by the outdoor unit temperature sensor 21. The indoor unit control device 301 allows the indoor unit communication device 302 to transmit a signal including data for the centralized management remote controller 10 to perform processing. The indoor unit communication device 302 serves as an interface for the indoor unit control device 301 to communicate (transmit and receive) with other devices via the exclusive transmission line 50.

The indoor unit 30 also includes an indoor unit temperature sensor 31 and an indoor unit humidity sensor 32. The indoor unit temperature sensor 31 is a detection device configured to detect temperature (air temperature) around the indoor unit 30, and the indoor unit humidity sensor 32 is a detection device configured to detect humidity (relative humidity) around the indoor unit 30. While the indoor unit temperature sensor 31 and the indoor unit humidity sensor 32 are described as components of the configuration of the indoor unit 30 in this example, the indoor unit temperature sensor 31 and the indoor unit humidity sensor 32 may be provided as separate units, for example, as long as the indoor unit temperature sensor 31 and the indoor unit humidity sensor 32 can detect temperature and humidity around the indoor unit 30.

The air-conditioning remote controller 60 transmits an instruction to the air-conditioning apparatus 2 by an operator (not shown) and informs the operator of the state of the air-conditioning apparatus 2 by display or indication, for example. In this example, in FIG. 1, one of the two air-conditioning remote controllers 60 is connected with the indoor unit 30, and the other is directly connected with the exclusive transmission line 50. The air-conditioning remote controller 60 connected with the indoor unit 30 can transmit and receive various types of signals to and from the indoor unit 30, the outdoor unit 20, and the centralized management remote controller 10, via the indoor unit 30. The air-conditioning remote controller 60 directly connected with the exclusive transmission line 50 can transmit and receive various types of signals to and from the centralized management remote controller 10, the outdoor unit 20, and the indoor unit 30 that are connected with the exclusive transmission line 50.

The air-conditioning remote controller 60 includes an air-conditioning remote controller control device 601 and an air-conditioning remote controller communication device 602. The air-conditioning remote controller control device 601 allows the air-conditioning remote controller communication device 602 to transmit signals including instructions input via the air-conditioning remote controller operation unit 64 and data based on physical amounts and other factors detected by various sensors in the air-conditioning remote controller 60. The air-conditioning remote controller communication device 602 serves as an interface for the air-conditioning remote controller control device 601 to communicate (transmit and receive) with other devices.

The air-conditioning remote controller 60 of Embodiment 1 also includes a human sensor 61, an illuminance sensor 62, and a temperature and humidity sensor 65. The human sensor 61 is configured of an infrared sensor or other related components, and detects heat (temperature) emitted from a human (object), for example. The air-conditioning remote controller control device 601 determines presence or absence of a human based on the heat detected by the human sensor 61. The illuminance sensor 62 detects illuminance around the air-conditioning remote controller 60. The temperature and humidity sensor 65 detects temperature and humidity around the air-conditioning remote controller 60.

The air-conditioning remote controller 60 of Embodiment 1 further includes an air-conditioning remote controller display unit 63 and an air-conditioning remote controller operation unit 64. The air-conditioning remote controller operation unit 64 transmits signals relating to instructions, input by an operator, of an operation command, a stop command, temperature setting, humidity setting, and other commands and settings to the outdoor unit 20, the indoor unit 30, and other components. Further, those signals are also transmitted to the centralized management remote controller 10 via the exclusive transmission line 50.

The air-conditioning remote controller display unit 63 displays, based on signals from the air-conditioning remote controller control device 601, a state of the air-conditioning apparatus 2 and data in a signal transmitted via the exclusive transmission line 50, for example. In this example, when the air-conditioning remote controller control device 601 determines that no human is present based on detection by the human sensor 61, the air-conditioning remote controller control device 601 turns off the backlight of the air-conditioning remote controller display unit 63. On the other hand, when the air-conditioning remote controller control device 601 determines that a human is present, the air-conditioning remote controller control device 601 turns on the backlight of the air-conditioning remote controller display unit 63. Thus, the configuration contributes to energy saving.

In Embodiment 1, the air-conditioning remote controller display unit 63 is a liquid crystal display, the air-conditioning remote controller operation unit 64 is a touchscreen, and the air-conditioning remote controller display unit 63 and the air-conditioning remote controller operation unit 64 are configured integrally. Thus, the operability can be enhanced. In this example, the contents displayed on the air-conditioning remote controller display unit 63 are switched to be changed based on an instruction input to the air-conditioning remote controller operation unit 64.

The air-conditioning remote controller operation unit 64 may be configured of a plurality of push buttons or other components. Further, various sensors such as the illuminance sensor 62, the human sensor 61, and the temperature and humidity sensor 65 may not be provided.

In the below description, a communication protocol is connected with a nondisclosed exclusive transmission line 50, and devices (the outdoor unit 20, the indoor unit 30, and the air-conditioning remote controller 60) constituting the air-conditioning apparatus 2 of Embodiment 1 relating to air conditioning of an air-conditioned space are referred to as air-conditioning devices.

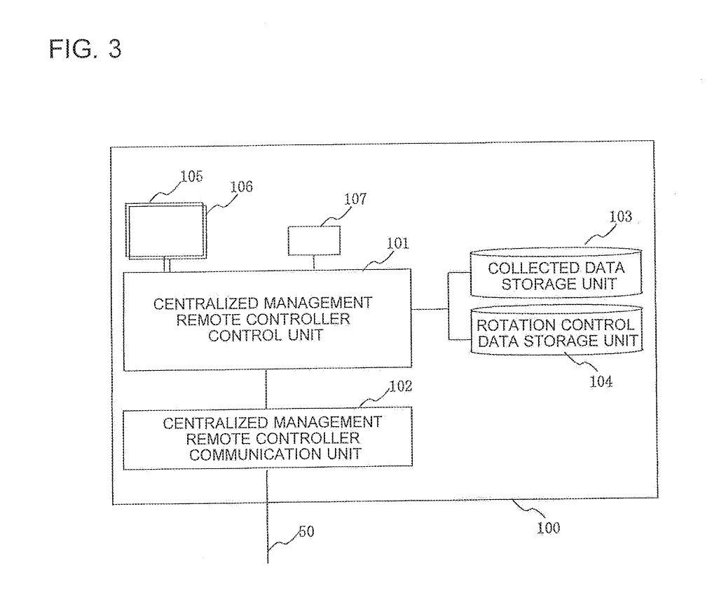

FIG. 3 is a diagram illustrating a configuration of the centralized management remote controller 10 according to Embodiment 1 of the present invention. The centralized management remote controller 10, serving as a management device of the air-conditioning system 1, includes a centralized management remote controller control unit 101, a centralized management remote controller communication unit 102, a collected data storage unit 103, a rotation control data storage unit 104, a centralized management remote controller display unit 105, a centralized management remote controller operation unit 106, and a centralized management remote controller timer unit 107.

The centralized management remote controller control unit 101 controls respective units of the centralized management remote controller 10, and also performs processing to control the entire air-conditioning system 1 of Embodiment 1. For example, the centralized management remote controller control unit 101 processes data included in a signal received via the centralized management remote controller communication unit 102 to control the air-conditioning apparatus 2 (air conditioning device) to be controlled.

In particular, the centralized management remote controller control unit 101 of Embodiment 1 processes rotation control described below, creates a rotation control command based on the data included in a received signal, and allows the command to be transmitted to the air-conditioning apparatus 2 (air-conditioning device) to be controlled, via the centralized management remote controller communication unit 102. The centralized management remote controller communication unit 102 serves as an interface for the centralized management remote controller control unit 101 to communicate (transmit and receive) with other devices via the exclusive transmission line 50.

The collected data storage unit 103 stores data included in a signal received via the centralized management remote controller communication unit 102. The rotation control data storage unit 104 stores data involved in rotation control performed by the centralized management remote controller control unit 101.

In this example, a signal is formed in a format conforming to the communication protocol used in a signal transmitted through the exclusive transmission line 50. A signal includes a header field containing a transmission source address, a transmission destination address, and actual data such as a telegram length of a communication command, a communication command field, and a frame check field containing a code for detecting a transmission error, for example.

The communication command field is configured of a communication command category field indicating a category of the communication command, an operation content field indicating the operation contents of the communication command, an operation target field indicating the operation target of the communication command, and other fields. The signal is an example and is not particularly limited to this example.

In the signal, the communication command field includes data such as humidity related to detection by the indoor unit humidity sensor 32, temperature related to detection by the indoor unit temperature sensor 31, and temperature related to detection by the outdoor unit temperature sensor 21. The signal also includes data such as heat related to detection by the human sensor 61, illuminance related to detection by the illuminance sensor 62, temperature and humidity related to detection by the temperature and humidity sensor 65, and an instruction from the air-conditioning remote controller operation unit 64.

The centralized management remote controller display unit 105 displays data stored in the collected data storage unit 103 and the rotation control data storage unit 104, for example, based on a signal transmitted from the centralized management remote controller control unit 101.

Further, the centralized management remote controller operation unit 106 transmits an instruction, input by an operator, to the centralized management remote controller control unit 101. In particular in Embodiment 1, an operator can input an instruction relating to setting of rotation control via the centralized management remote controller operation unit 106, using screens such as an edit area and an input window displayed on the centralized management remote controller display unit 105. Then, the centralized management remote controller timer unit 107 performs timing (counting) of the time of a rotation interval of the air-conditioning apparatus 2, for example.

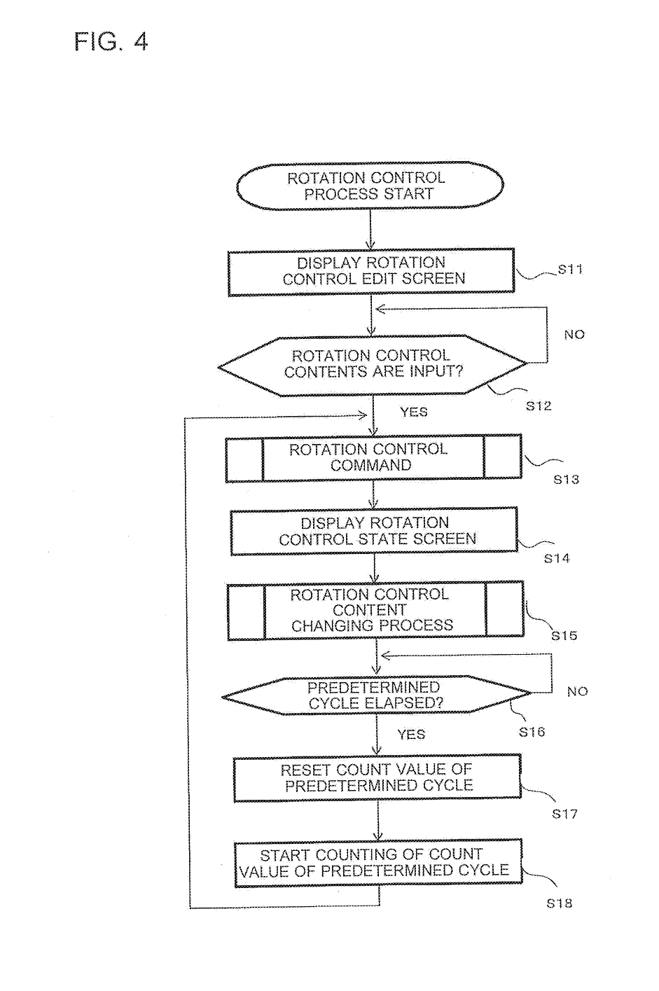

FIG. 4 is a flowchart relating to an example of rotation control performed by the centralized management remote controller 10 according to Embodiment 1 of the present invention. Next, operation of rotation control will be described with reference to FIG. 4, based on the above description.

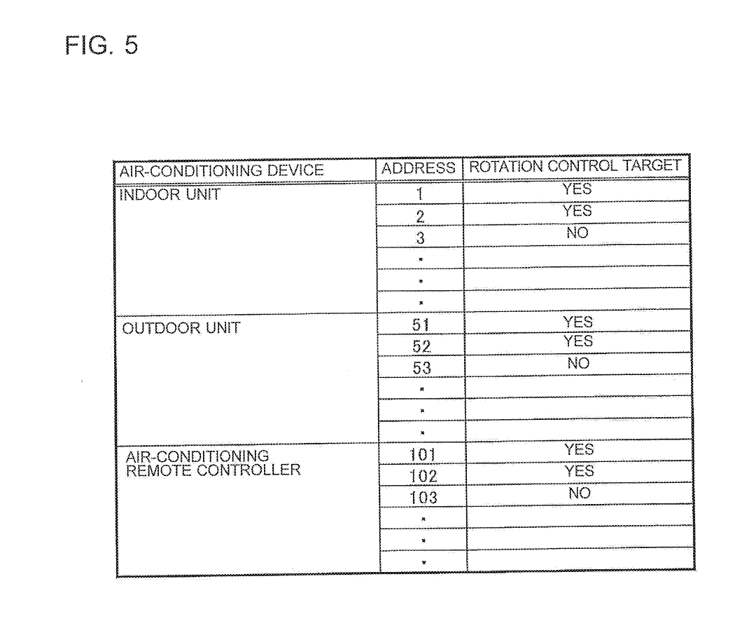

FIG. 5 is a diagram illustrating an example of a rotation control edit screen according to Embodiment 1 of the present invention. At step S11, the centralized management remote controller control unit 101 of the centralized management remote controller 10 allows the centralized management remote controller display unit 105 to display a rotation control edit screen. An operator uses the centralized management remote controller operation unit 106 to designate a target air-conditioning device of rotation control and input contents of rotation control.

At step S12, the centralized management remote controller control unit 101 determines whether or not an operator designates an air-conditioning device and inputs contents of rotation control via the centralized management remote controller operation unit 106. Then, the centralized management remote controller control unit 101 waits until contents of rotation control are input. On the other hand, when the centralized management remote controller control unit 101 determines that contents of rotation control are input, the centralized management remote controller control unit 101 proceeds to step S13.

At step S13, the centralized management remote controller control unit 101 processes a rotation control command described below, ends the processing of the rotation control command, and proceeds to step S14.

At step S14, the centralized management remote controller control unit 101 displays the control contents on which input is determined at step S12 and contents of rotation control described below, and proceeds to step S15.

At step S15, the centralized management remote controller control unit 101 performs a rotation control content changing process described below, and proceeds to step S16.

At step S16, the centralized management remote controller control unit 101 determines whether or not a predetermined first cycle has elapsed. The centralized management remote controller control unit 101 waits until the first cycle has elapsed. When the centralized management remote controller control unit 101 determines that the first cycle has elapsed, the centralized management remote controller control unit 101 proceeds to step S17.

At step S17, the centralized management remote controller control unit 101 resets the count value of the first cycle, and proceeds to step S18.

At step S18, the centralized management remote controller control unit 101 starts counting of the count value of the first cycle, and returns to step S13.

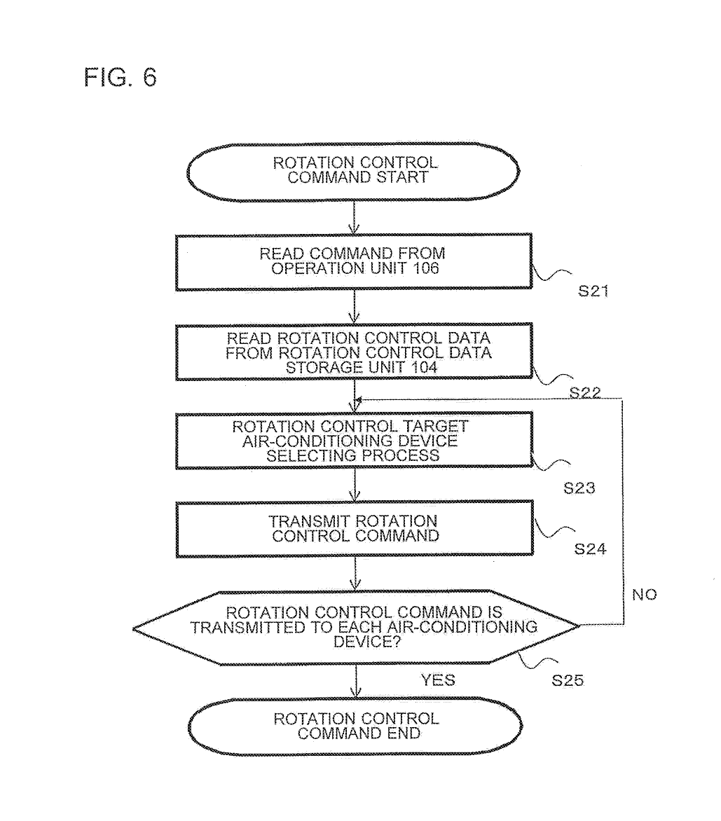

FIG. 6 is a flowchart of a detailed example of a rotation control command performed by the centralized management remote controller control unit 101 according to Embodiment 1 of the present invention.

At step S21, when the centralized management remote controller control unit 101 acquires data (rotation control target data) relating to an air-conditioning device to be a target of rotation control, based on a signal from the centralized management remote controller operation unit 106, the centralized management remote controller control unit 101 proceeds to step S22.

At step S22, the centralized management remote controller control unit 101 reads rotation control data from the rotation control data storage unit 104, and proceeds to step S23. The contents of rotation control data stored in the rotation control data storage unit 104 will be described below.

At step S23, the centralized management remote controller control unit 101 determines an air-conditioning device to be a target of rotation control, based on the rotation control target data and the rotation control data. Then, the centralized management remote controller control unit 101 processes the contents of the rotation control data, creates a rotation control command, and proceeds to step S24.

At step S24, the centralized management remote controller control unit 101 allows the centralized management remote controller communication unit 102 to transmit the rotation control command to the air-conditioning device to be a target of rotation control via the exclusive transmission line 50, and proceeds to step S25.

At step S25, the centralized management remote controller control unit 101 determines whether or not the rotation control command has been transmitted to all air-conditioning devices to be targets of rotation control. When the centralized management remote controller control unit 101 determines that the rotation control command has been transmitted to all the air-conditioning devices, the centralized management remote controller control unit 101 ends the processing. Meanwhile, when the centralized management remote controller control unit 101 determines that the rotation control command has not been transmitted to all the air-conditioning devices, the centralized management remote controller control unit 101 returns to step S25.

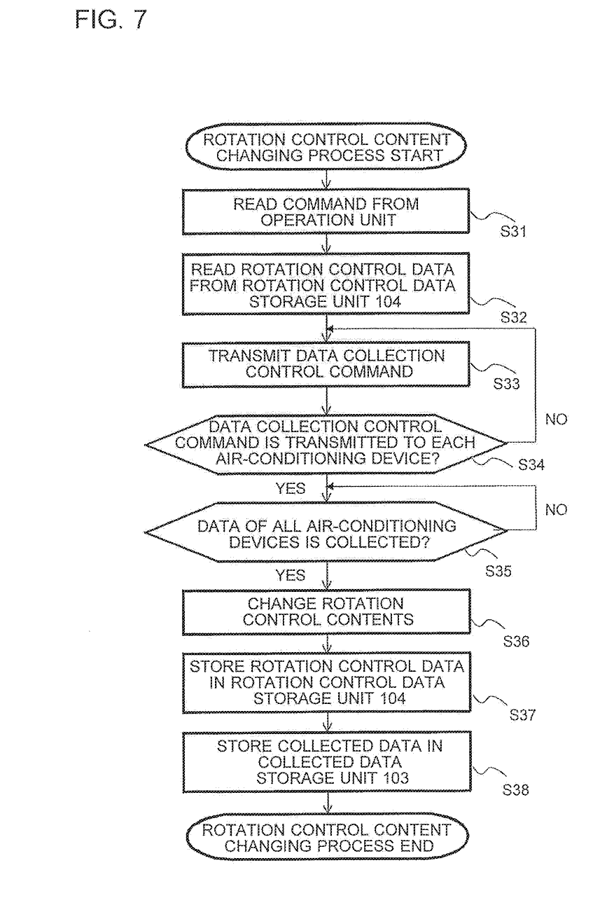

FIG. 7 is a flowchart relating to an example of a rotation control content changing process performed by the centralized management remote controller 10 according to Embodiment 1 of the present invention. Next, a process relating to a change in the contents of rotation control will be described with reference to FIG. 7.

At step S31, when the centralized management remote controller control unit 101 acquires data (rotation control change target data) relating to an air-conditioning device to be a target of rotation control change based on a signal from the centralized management remote controller operation unit 106, the centralized management remote controller control unit 101 proceeds to step S32.

At step S32, the centralized management remote controller control unit 101 reads rotation control data from the rotation control data storage unit 104, and proceeds to step S33.

FIG. 8 is a diagram illustrating an example of rotation control data according to Embodiment 1 of the present invention. The rotation control data storage unit 104 stores, as data, the contents of a rotation control command transmitted by the centralized management remote controller 10 to an air-conditioning device via the exclusive transmission line 50.

A control content field is a field indicating the contents of control performed in rotation control. For example, in FIG. 8, four control contents, namely “rotation interval”, “operation” “set temperature”, and “demand control” are transmitted as a rotation control command to the air-conditioning apparatus 2 side to control the air-conditioning apparatus 2. Further, a setting field is a field indicating set contents of the respective control contents. For example, “unlimited”, “30 minutes”, “20 minutes”, or “10 minutes” can be set in the case where the control content is “rotation interval”. Then, based on the data transmitted from the air-conditioning device, reference values for setting the rotation interval, operating state, and other factors of the air-conditioning apparatus 2 are set for the respective settings.

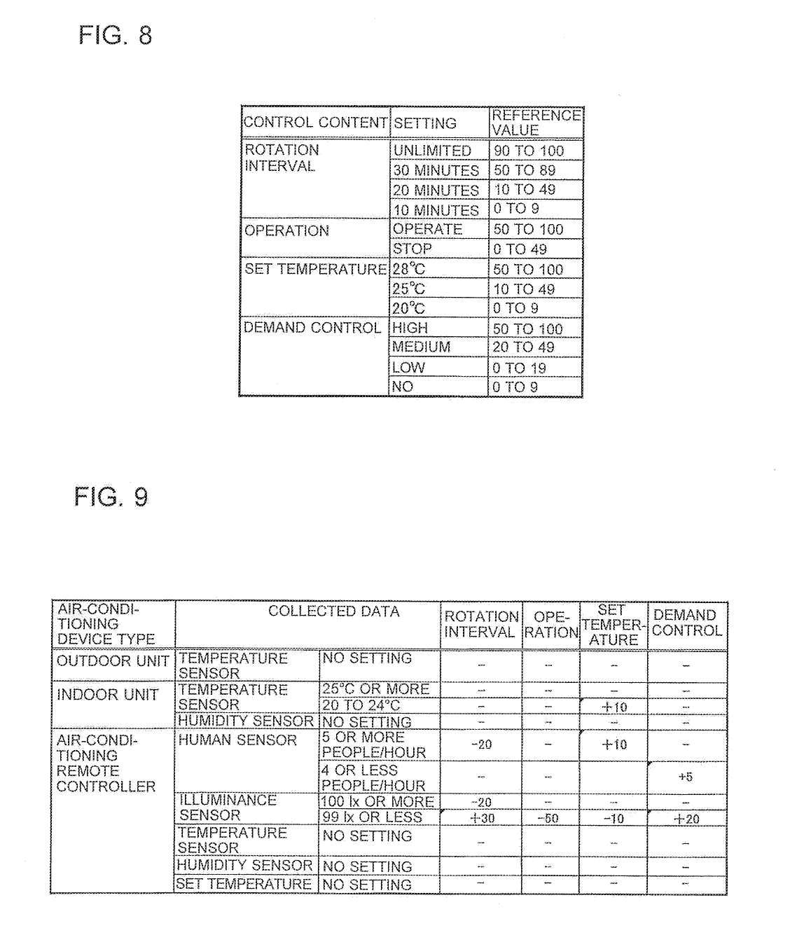

FIG. 9 is a diagram illustrating an example of data stored in the rotation control data storage unit 104 according to Embodiment 1 of the present invention. In the rotation control data storage unit 104, relationships between the results indicated by data collected from air conditioning devices and the numerical values set for the respective control contents are stored as data.

For example, as shown in FIG. 9, when the detection result by the human sensor 61, received from the air-conditioning remote controller 60, is 10 people per hour, a numerical value of “rotation interval” is set to −20, and a numerical value of “set temperature” is set to +10.

The centralized management remote controller control unit 101 uses a value calculated by adding the numerical value obtained for each of the control contents as a reference value. Then, as a result of processing, when the reference value of the rotation interval field is 80, for example, the centralized management remote controller control unit 101 allows a setting (“30 minutes”), corresponding to the reference value shown in FIG. 8, to be included in the rotation control command. Further, when the reference value of the “set temperature” field is 30, a setting “25 degrees C.”, corresponding to the reference value of 30, is included in the rotation control command.

At step S33, the centralized management remote controller control unit 101 transmits a data collection control command to the air conditioning device to acquire data required for changing the rotation control contents via the exclusive transmission line 50, and proceeds to step S34.

At step S34, the centralized management remote controller control unit 101 determines whether or not the data collection control command is transmitted to all air-conditioning devices. When the centralized management remote controller control unit 101 determines that the data collection control command is transmitted to all air-conditioning devices, the centralized management remote controller control unit 101 proceeds to step S35. On the other hand, when the centralized management remote controller control unit 101 determines that the data collection control command is not transmitted to all air-conditioning devices, the centralized management remote controller control unit 101 returns to step S33, and transmits the data collection control command to an air-conditioning device to which the command has not been transmitted.

At step S35, the centralized management remote controller control unit 101 determines whether or not data collection from all air-conditioning devices has been completed. When the centralized management remote controller control unit 101 determines that data collection from all air-conditioning devices has been completed, the centralized management remote controller control unit 101 proceeds to step S36. On the other hand, when the centralized management remote controller control unit 101 determines that data collection from all air-conditioning devices has not been completed, the centralized management remote controller control unit 101 returns to step S35 and continues data collection.

At step S36, the centralized management remote controller control unit 101 changes the contents of the rotation control command based on the data from all air-conditioning devices, and proceeds to step S37.

At step S37, the centralized management remote controller control unit 101 stores the changed data of rotation control in the rotation control data storage unit 104, and proceeds to step S38. Here, the data stored in the rotation control data storage unit 104 is displayed on the centralized management remote controller display unit 105 to allow the user to refer to the data. Further, the centralized management remote controller operation unit 106 can allow the user to input a change instruction of the data of the rotation control command to edit the data.

At step S38, the centralized management remote controller control unit 01 stores the collected data in the collected data storage unit 103, and ends the processing. Here, the data stored in the collected data storage unit 103 is displayed on the centralized management remote controller display unit 105 to allow the user to refer to the data.

As described above, in the air-conditioning system 1 of Embodiment 1, the centralized management remote controller 10 and the air-conditioning devices are connected communicably with each other via the exclusive transmission line 50, and the centralized management remote controller 10 is configured to perform processing to change the contents of a rotation control command based on the operating states of the air-conditioning devices. Thus, the control can be changed by transmitting a rotation control command changed depending on the air conditioning load, to each of the air-conditioning devices. Consequently, energy saving and comfortability can be enhanced in the entire air-conditioning system.

### Embodiment 2

Although Embodiment 1 described above does not illustrate, data of rotation control performed by each air-conditioning apparatus 2 may be stored in the rotation control data storage unit 104 in the air-conditioning system. Thus, in the case where the power consumption of the entire air-conditioning system 1 is required to be kept within a prescribed electric power amount, for example, the order of demand controls to be performed can be defined based on the data of rotation control.

For example, control can be performed to keep the power consumption of the entire air-conditioning system 1 within the prescribed electric power amount by performing demand control from the air-conditioning apparatus 2 in which the accumulated operation time is long, on the basis of the accumulated operation time based on the total rotation intervals of each of the air-conditioning apparatuses 2.

### REFERENCE SIGNS LIST

1 air-conditioning system 2 air-conditioning apparatus 10 centralized management remote controller 20 outdoor unit 21 outdoor unit temperature sensor 30 indoor unit 31 indoor unit temperature sensor 32 indoor unit humidity sensor 40 refrigerant pipe 50 exclusive transmission line 60 air-conditioning remote controller 61 human sensor 62 illuminance sensor 63 air-conditioning remote controller display unit 64 air-conditioning remote controller operation unit 65 humidity sensor 101 centralized management remote controller control unit 102 centralized management remote controller communication unit 103 collected data storage unit, 104 rotation control data storage unit 105 centralized management remote controller display unit

106 centralized management remote controller operation unit 107 centralized management remote controller timer unit 201 outdoor unit control device 202 outdoor unit communication device 301 indoor unit control device 302 indoor unit communication device 601 air-conditioning remote controller control device 602 air-conditioning remote controller communication device

1. An air-conditioning system comprising:
air-conditioning apparatuses each including an air-conditioning device involved in air conditioning of an air-conditioned space;
a management device configured to perform rotation control in which an operating state of each of the air-conditioning apparatuses is controlled by being set to be switched for each rotation interval; and
at least one of an illuminance sensor and a human sensor installed in the air-conditioned space,
the management device including
a communication unit configured to communicate with the air-conditioning device, and
a controller configured to set the rotation interval depending on an air conditioning load of each of the air-conditioning apparatuses based on data transmitted from the air-conditioning device through communications with the communication unit when the controller sets the operating state of each of the air-conditioning apparatuses.

2. The air-conditioning system of claim 1, wherein each of the air-conditioning apparatuses includes an air-conditioning remote controller including at least one of the illuminance sensor and the human sensor.

3. The air-conditioning system of claim 1, wherein
the management device has data in which a setting and a reference value are associated with each other for each control content of the operating state performed in the rotation control, and
the controller converts data transmitted from the air-conditioning device into a numerical value for each control content of the rotation control, and sets the operating state and the rotation interval based on the setting associated with the reference value corresponding to the numerical value.

4. The air-conditioning system of claim 1, wherein
the management device further includes a storage unit configured to store the rotation interval in each of the air-conditioning apparatuses, and
when the controller determines that power consumption of the entire air-conditioning system exceeds a prescribed power amount, the controller determines an order of the air-conditioning apparatuses to which a demand control command is transmitted to keep the power consumption within the prescribed power amount, based on the rotation intervals of the air-conditioning apparatuses stored in the storage unit.

5. The air-conditioning system of claim 1, wherein the controller is configured to decrease the rotation interval when the number of people in the air-conditioned space detected by the human sensor is larger than a predetermined number of people.

6. The air-conditioning system of claim 1, wherein the controller is configured to increase the rotation interval when illuminance in the air-conditioned space detected by the illuminance sensor is smaller than a predetermined illuminance.

7. The air-conditioning system of claim 1, wherein the controller is configured to decrease an operation time of the air-conditioning device when illuminance in the air-conditioned space detected by the illuminance sensor is smaller than a predetermined illuminance.

8. The air-conditioning system of claim 1, wherein the air-conditioning apparatuses each further including a temperature sensor and a humidity sensor.

9. The air-conditioning system of claim 4, wherein the controller is configured to transmit the demand control command to keep the power consumption within the prescribed power amount when the number of people in the air-conditioned space detected by the human sensor is smaller than a predetermined number of people.

10. The air-conditioning system of claim 4, wherein the controller is configured to transmit the demand control command to keep the power consumption within the prescribed power amount when illuminance in the air-conditioned space detected by the illuminance sensor is smaller than a predetermined illuminance.
